(19) United States
(12) Patent Application Publication
(10) Pub. No.: US 2001/0012373 A1
(43) Pub. Date: Aug. 9, 2001

(54) Garment-worn microphone, and communication system and method employing such a microphone for voice control of devices

(75) Inventor: Rainer Graumann, Hoechstadt (DE)

Correspondence Address: SCHIFF HARDIN & WAITE, 6600 SEARS TOWER, 233 S WACKER DR, CHICAGO, IL, 60606-6473, US

(73) Assignee: Siemens Aktiengesellschaft

(21) Appl. No.: 09/778,497

(22) Filed: Feb. 7, 2001

(30) Foreign Application Priority Data
Feb. 9, 2000 (DE) 10005626.1

(51) Int. Cl. H04R 9/08; H04R 19/04

(52) U.S. Cl. 381/364; 381/361

(57) ABSTRACT

In a garment having a microphone integrated therein, and a communication system and method employing such a garment, the garment is either a facemask or a neckband with the microphone integrated in the facemask or neckband. The communication system also includes a reception unit, located remote from the garment, which receives and processes signals from the microphone.

### BACKGROUND OF THE INVENTION

1. Field of the Invention

The invention relates to an arrangement for picking up voice signals, a communication device employing such an arrangement and to a method for voice control of devices.

2. Description of the Prior Art

The control of devices by voice and the pickup and storage of voice signals for the purpose have become increasingly important in many technology fields. For example, devices controlled by voice are increasingly used in the medical field with respect to surgical operations and interventional treatments in order to reduce personnel. In order to make it possible for a surgeon to control devices by voice, it is required to use at least one microphone for recording and converting the voice signals into electrical signals, and means for evaluating the converted voice signals, for example in the form of a voice recognition system. The voice signals can be picked up by directional microphones, for example, which can be arranged at a distance from the surgeon in order to avoid impairment to the surgeon as a result of the microphones. Such directional microphones, however, have not succeeded in practical use, since the noise of the environment is also recorded together with the voice signals of the surgeon, so that unambiguous voice recognition becomes difficult.

German OS 32 24 535, for example, discloses a coat or a jacket having speakers arranged at the collar of the coat or jacket and having a microphone arranged close to the chin of the person wearing the coat or jacket. The speakers and the microphone make it possible for a person to communicate with other persons, to listen to music, or to record voice.

Headsets are known which are worn at the head and which have a holder leading to the mouth of the person wearing the headset, with a microphone attached at the end of the holder for picking up voice signals. The acceptance of these headsets, particularly with respect to surgeons, is low due to a lack of convenience.

### SUMMARY OF THE INVENTION

An object of the present invention is to provide a microphone for recording voice signals which can be worn such that the person does not consider the microphone as disturbing.

The object is inventively achieved by a facemask or a neckband into which a microphone is integrated. Integrating a microphone into the facemask or the neckband means that the microphone is situated in the inside of the facemask or the neckband, for example between two fabric layers. The microphone can be situated in a pocket provided for the microphone, which can be closed by a zipper or a snap, for example, or can be firmly connected to the facemask or neckband by being sewed therein so that it cannot be removed. The microphone can be inventively integrated into the facemask or neckband such that the microphone can be taken out of the facemask or neckband prior to the cleaning of the facemask or neckband, for example. Alternatively, the microphone can be connected to the facemask or neckband such that the facemask or the neckband would have to be destroyed or damaged if the microphone were to be removed therefrom. This is preferably the case when the facemask or the neckband is an article for one-time use. The microphone is preferably proportioned and located in the facemask or neckband such that the person wearing the facemask or neckband does not notice the microphone even when he or she wears the facemask or neckband. A microphone thus can be provided in a way that is comfortable for the person wearing it.

In a preferred embodiment of the invention, the facemask or the neckband is provided for having worn in an operating room. According to a version of the invention, the microphone is fashioned in the form of a larynx microphone given the integration of the microphone into a neckband, in particular. As a result of the integration of a microphone into a facemask or into a neckband, the surgeon need not wear a headset, which has a low acceptance in the medical field. The facemask or the neckband provided for wear in the operating room can be a single-use clothing article maintaining sterile conditions.

In a further embodiment of the invention the facemask or neckband, at its exterior is provided with at least one contact that is electrically connected to the microphone. The cable is provided with a mating contact and transmits electrical signals generated from voice signals by the microphone to a reception unit that can be contacted with the cable. The cable can be connected to the contact arranged at the exterior of the facemask or neckband. In another embodiment of the invention, the microphone has a connecting cable for directly transmitting the electrical signals generated from the voice signals by the microphone to a reception unit. The connecting cable extends from the microphone through an opening of the facemask or the neckband from the inside of the facemask or the neckband to the outside and is preferably provided with a plug that can be connected to the reception unit. This embodiment with the microphone integrated into a facemask or neckband has proven to be relatively insensitive to disturbances in transmitting the electrical signals, which are generated from voice signals, from the microphone to a reception unit.

In some instances the transmission of the signals from the microphone to the reception unit using a cable may be disturbing insofar as the cable may interfere with movement or positioning within the work place. In an alternative embodiment, therefore, in addition to the microphone, a transmission device for wirelessly transmitting the electrical signals generated by the microphone to a remote reception unit is provided. The transmission device is arranged at the exterior surface of the facemask or the neckband at which the microphone is located. The voice signals are thereby transmitted by signal-carrying waves.

In a version of the invention, the microphone has at least one electronic filter circuit for suppressing disturb signals caused by noises contained in the electrical signals generated from the voice signals by the microphone. For example, the noises may be breathing sounds, swallowing sounds or sounds as a result of fabric brushing the microphone, which can be suppressed by adaptive filter circuits such as RC filters. The filter circuits make it possible to unambiguously recognize the voice signals.

A communication device in accordance with the invention has a facemask or a neckband with an integrated microphone and a reception unit for the electrical signals generated by the microphone from the voice signals. The reception unit can be provided for storing the electrical signals generated from the voice signals. Alternatively, the reception unit can be inventively provided for converting the electrical signals generated from the voice signals into signals for controlling remote devices. A simple storage medium such as a tape or a disc that is accepted in an recording unit can be used. The storage can alternatively be carried out by a component of a voice recognition system for converting voice signals into written words. This is particularly advantageous when the communication device is provided for a running vocal evaluation of an interventional procedure, so that the voice signals translated into written words can be simply utilized for a medical report, for example.

In an embodiment the reception unit has at least one electrical filter circuit for suppressing disturbing signals caused by noises which are contained in the electrical signals generated by the microphone from the voice signals. In this way, it is possible for the communication device to unambiguously recognize the voice signals.

The invention also relates to a method for the utilization of a microphone integrated into a garment for the voice control of devices. Integration of a microphone into a garment is used herein in the same way as the above-described integration of a microphone into a facemask or neckband.

### DESCRIPTION OF THE DRAWINGS

FIG. 1 shows a medical workplace with a communication device with a microphone, which is integrated into a facemask, in accordance with the invention.

FIG. 2 shows a medical workplace with a communication device with a larynx microphone, which is integrated into a neckband, in accordance with the invention.

FIG. 3 shows a surgeon's overall with an integrated microphone in accordance with the invention.

FIG. 4 shows a facemask with an integrated microphone and connecting cable in accordance with the invention.

### DESCRIPTION OF THE PREFERRED EMBODIMENTS

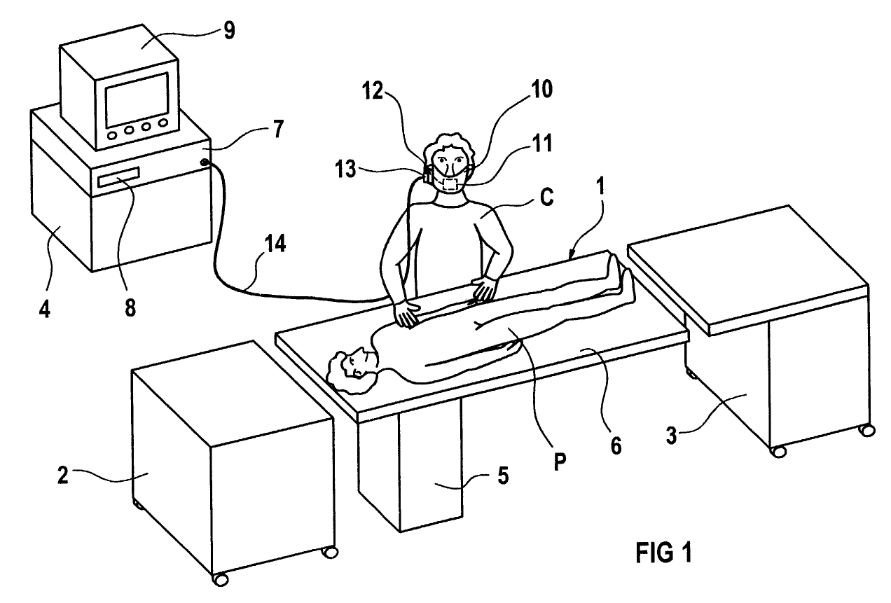

The medical workplace shown in FIG. 1 is a surgical operating room. The schematically shown workplace contains a patient table 1, an anaesthesia device 2, an instrument table 3 and a device cabinet 4.

The patient table 1 has a vertically displaceable lifting support 5 and a patient support plate 6 on which a patient P is borne. The anaesthesia device 2, is located at the patient table 1, and in a known manner has units for narcotizing, de-narcotizing and monitoring the vital functions of the patient P. The instrument table 3 is also located at the patient table 1, and in a known manner provides applicators and operation materials for the surgical intervention at the patient. The device cabinet 4 contains medical technical devices such as an ultrasound device, a rinsing-suction pump control, an insufflator, an HF device and a cold light source. The devices have respective applicators such as an ultrasound head, a rinsing-suction applicator, an insufflation applicator, a HF scalpel and cold light, which are connected to the corresponding medical-technical devices via suitable connecting lines. The applicators are kept available on the instrument table 3 for a surgeon C working in the workplace.

The device cabinet 4 also contains a computer 7 with a storage device for storing digital data. In the exemplary embodiment, the storage device is a hard disk 8, which is schematically indicated in FIG. 1. The computer 7 is connected to the medical-technical devices contained in the device cabinet 4 and to the medical-technical devices of the anaesthesia device 2 so that a data exchange is possible between the computer 7 and the medical-technical devices. The networking of the computer 7 with the medical-technical devices of the workplace makes it possible for the surgeon C, centrally from the patient bearing table 1, to operate the medical-technical devices by himself or herself in a voice-controlled manner without further staff. For this purpose, an operating menu is displayed at a monitor 9 that is connected to the computer 7. This operating menu contains operating points allocated to the individual medical devices, so that the surgeon C can select these in a voice-controlled manner in order to be able to carry out adjustments at the respective devices by further voice inputs. The monitor 9 preferably is arranged in the viewing field of the surgeon C.

The workplace has a communication device in order to be able to operate the medical-technical devices of the medical workplace in a voice-controlled fashion.

In the exemplary embodiment, the communication device includes a facemask 10, which is worn by the surgeon C and in which a microphone is integrated, and a reception device for receiving and evaluating electrical signals generated from voice signals by the microphone. In the exemplary embodiment, the microphone 11 is sewed between two fabric surfaces of the facemask 10. A cable extending in the interior space, i.e., between the sewed fabric surfaces of the facemask 10, is led to an electrical contact 12, which is situated at the surface of the facemask 10 and is accessible from the exterior thereof. A cable 14, which is provided with a corresponding mating contact 13, is connected to the contact 12. The cable 14 is led to the computer 7, which, in the exemplary embodiment, serves as the reception device for the electrical signals generated from the voice signals of the surgeon C by the microphone. The computer 7, operated by suitable software, converts the electrical signals generated by the microphone 11 from the voice signals of the surgeon C into operating signals for the operating menu displayed at the display device 9, and into control signals for the medical-technical device respectively selected from the operating menu. For example, the surgeon C can select the cold light source in a voice-controlled manner and can switch on or switch off the cold light source, for example, on the basis of further voice inputs.

In addition to the voice control for operating medical-technical devices, it is also possible to store the words spoken by the surgeon C via the operating menu, so that a running (contemporaneous) vocal evaluation is possible, for example. The voice signals can be intermediately stored in a digital form on the hard disk 8 or on other storage mediums, such as disks or on a tape of a magnetic tape recorder, for later playback. It is particularly advantageous when the computer 7 is operated by a voice recognition software, so that the words spoken by the surgeon C can be directly translated into written words.

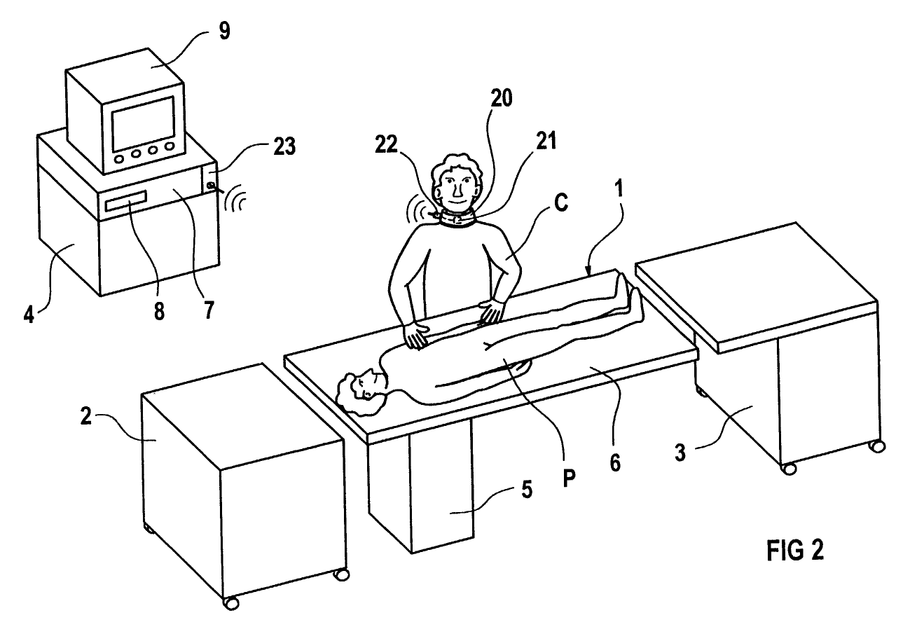

Apart from the communication device, the medical workplace shown in FIG. 2 is the same as the medical workplace shown in FIG. 1. Instead of the embodiment of the communication device shown in FIG. 1, the communication device of FIG. 2 has a neckband 20 worn by the surgeon C, with a larynx microphone 21 is integrated into the neckband 20. The larynx microphone 21 is completely integrated into the neckband 20, i.e., it is covered by fabric, and is arranged in the inside of the neckband 20, and therefore is not accessible without destroying the fabric of the neckband 20. A transmission device 22 for signal-carrying waves is connected to the microphone 21 and is arranged at the surface of the neckband 20. This transmission device 22 wirelessly transmits the electrical signals generated by the microphone 21 from the voice signals of the surgeon C to a reception unit 23. The reception unit 23 for signal-carrying waves is connected to the computer 7, which, in turn, evaluates the electrical signals generated from the voice signals and converts them into operating signals for the operating menu or into control signals for the medical-technical devices.

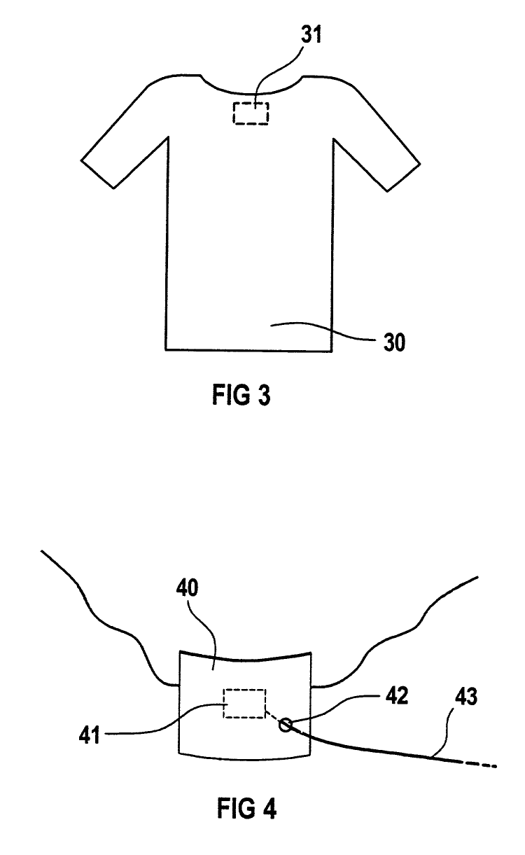

The arrangement of a microphone in a garment that can be worn in the operating room, such as the facemask 10 shown in FIG. 1 or the neckband 20 shown in FIG. 2, or the surgeon's coverall 30 provided with a microphone 31 shown in FIG. 3, has the advantage that the microphone for recording voice signals is situated close to the voice generation center of a person wearing such a garment and the person does not experience the microphone as unpleasant and disturbing.

FIG. 4 shows a further embodiment of a garment in the form of a facemask 40, wherein the microphone 41 integrated into the facemask 40 is provided with a cable 43 extending from the facemask 40 through an opening 42. The cable 43 has a length that which allows it to be directly connected to a reception unit for the electrical signals that are generated by the microphone 41 from voice signals.

Each of the described microphones and/or each of the described reception unit can include (in a way that is not shown) one electrical filter circuit for processing the signals in order to suppress disturbing signals caused by noises, such disturbing signals being contained in the electrical signals generated by the microphone from the voice signals.

Although modifications and changes may be suggested by those skilled in the art, it is the intention of the inventor to embody within the patent warranted hereon all changes and modifications as reasonably and properly come within the scope of his contribution to the art.

I claim as my invention:

1. A garment selected from the group consisting of a facemask and a neckband, having a microphone integrated in the garment.

2. A garment as claimed in claim 1 adapted to be worn in a medical operating environment.

3. A garment as claimed in claim 1 wherein said microphone is a larynx microphone.

4. A garment as claimed in claim 1 further comprising a contact electrically connected to the microphone disposed at an exterior surface of the garment, and a cable having a mating contact, engageable with said contact, for transmitting signals from said microphone to a remote location.

5. A garment as claimed in claim 1 further comprising a cable connected to said microphone for transmitting signals from said microphone to a remote location, said garment having an interior and an exterior and said microphone being disposed in the interior of said garment, and said garment having an opening through which said cable proceeds from said interior of said garment to said exterior of said garment.

6. A garment as claimed in claim 1 further comprising a wireless transmitter electrically connected to said microphone for wirelessly transmitting signals generated by said microphone to a remote location.

7. A garment as claimed in claim 1 wherein said microphone includes an electrical filter circuit for suppressing disturbing signals caused by noises picked up by said microphone, said disturbing signals being contained in electrical signals generated by said microphone from voice signals.

8. A communication system comprising:
a garment selected from the group consisting of a facemask and a neckband;
a microphone integrated in said garment; and
a reception unit disposed remote from said microphone; and
a signal transmitting arrangement for transmitting signals, corresponding to voice signals picked up by said microphone, from said microphone to said reception unit.

9. A communication system as claimed in claim 8 wherein said signal transmitting arrangement comprises a cable electrically connecting said microphone and said reception unit.

10. A communication system as claimed in claim 8 wherein said signal transmitting arrangement comprises a wireless transmitter electrically connected to said microphone and located at said garment, and a wireless receiver located at said reception unit for receiving signals from said wireless transmitter.

11. A communication system as claimed in claim 8 wherein said reception unit includes means for transmitting electrical signals produced by said microphone, corresponding to voice signals, into at least one control signal for operating at least one device.

12. A communication system as claimed in claim 8 wherein said reception unit includes at least one electrical filter circuit for suppressing disturbing signals caused by noises, which are contained in electrical signals generated by the microphone from voice signals.

13. A method for controlling a device comprising the steps of:
integrating a microphone into a garment;
speaking voice commands into said microphone, which are converted into electrical signals by said microphone;
communicating said electrical signals to a reception unit located remotely from said microphone; and
from said reception unit, producing control signals for controlling at least one device located remote from said microphone.

14. A method as claimed in claim 13 wherein the step of controlling at least one device comprises controlling a medical-technical device in a medical operating environment.

15. A method as claimed in claim 13 comprising integrating said microphone into a garment selected from the group consisting of a facemask and a neckband.

16. A method as claimed in claim 13 comprising the step of employing a larynx microphone as said microphone.

17. A method as claimed in claim 13 wherein the step of transmitting said signals comprises electrically connecting a contact to said microphone and making said contact accessible at an exterior surface of said garment, connecting a mating contact at a first end of an electrical cable to said contact, and connecting an opposite end of said cable to said reception unit, and transmitting said signals via said cable to said reception unit.

18. A method as claimed in claim 13 wherein the step of integrating said microphone in said garment comprises disposing said microphone in an interior of said garment, and wherein the step of transmitting said signals comprises providing an electrical cable in electrical connection with said microphone and guiding said cable through an opening in said garment from an interior of said garment to an exterior of said garment, and connecting an opposite end of said cable to said reception unit.

19. A method as claimed in claim 13 wherein the step of transmitting signals comprises providing a wireless transmitter in electrical connection with said microphone, providing a wireless receiver at said reception unit, and wirelessly transmitting said signals produced by said microphone from said transmitter to said receiver.

20. A method as claimed in claim 13 comprising electrically filtering signals from said microphone to suppress disturbing signals therein produced by noises picked up by said microphone.
